(19) United States
(12) Patent Application Publication
(10) Pub. No.: US 2013/0215506 A1
(43) Pub. Date: Aug. 22, 2013

(54) REFLECTIVE POLARIZER

(71) Applicant: National Tsing Hua University, (US)

(72) Inventors: Po-Hung YAO, Hsinchu (TW); Cheng-Huan CHEN, Hsinchu (TW); Chi-Jui CHUNG, Hsinchu (TW); Chien-Li WU, Hsinchu (TW)

(73) Assignee: NATIONAL TSING HUA UNIVERSITY, Hsinchu (TW)

(21) Appl. No.: 13/765,355

(22) Filed: Feb. 12, 2013

(30) Foreign Application Priority Data
Feb. 17, 2012 (TW) 101105213

(51) Int. Cl. G02B 5/30

(52) U.S. Cl. CPC G02B 5/3058
USPC 359/485.03

(57) ABSTRACT

A reflective polarizer comprises a light-permeable substrate and a grating structure. The grating structure is disposed on the light-permeable substrate and includes a first grating layer and a second grating layer. The first grating layer includes a first array containing a plurality of first metallic units. The second grating layer is stacked on the first grating layer and includes a second array containing a plurality of second metallic units. The first metallic units and the second metallic units are respectively made of different metallic materials. The abovementioned reflective polarizer can improve the transmittance of the short-wavelength light and the spectral response uniformity of the element without increasing the difficulty of fabricating the molds of the nanograting structure.

### BACKGROUND OF THE INVENTION

1. Field of the Invention

The present invention relates to a polarizer, particularly to a reflective polarizer containing a nanograting structure made of a plurality of metallic materials.

2. Description of the Prior Art

A conventional reflective polarizer uses nanograting structures to modulate polarization of incident light, allowing light having a specified polarization direction to pass and reflecting the light having other polarization directions. The transmittance spectrum of the reflective polarizer has an absolute association with the geometrical design of the nanograting structure. The greater the extent by which the nanograting structure is smaller than the operating wavelength, the more uniform and efficient the transmittance spectrum of the 0th-order diffracted light, and the higher the extinction ratio. However, the nanograting structure with a higher transmittance has a shorter period, a smaller line width and a higher aspect ratio and thus is harder to fabricate.

A dual-layer grating structure, which is formed by stacking a metal (such as aluminum) structure and a dielectric structure, is used to improve the transmittance of the reflective polarizer. However, the metal-dielectric dual-layer nanograting structure can only modulate the incident electromagnetic waves to a limited extent. The high aspect ratio, which is required by the grating to achieve high transmittance and high extinction ratio in the full-spectrum of visible light, will further increase the difficulty of fabricating the grating structure.

The nanograting structure made of a single metallic material (such as aluminum) would need a 100 nm-scale structure period and an aspect ratio of as high as from 3 to 4 or more if a fine extinction ratio is desired. The abovementioned structure can indeed improve the extinction ratio. However, the increased thickness of the metal layer decreases the transmittance. Further, a high aspect ratio structure is much harder to fabricate. Considering the fabrication capability, a grating structure may adopt a greater line width. However, a greater line width would decrease the extinction ratio and lower the uniformity of the spectral transmittance. Refer to FIG. 1 for the characteristic curves of an aluminum-based nanograting element having a structure period of 100 nm, an aspect ratio of 4 and a height of 220 nm, wherein the solid curve is the transmittance, the dashed curve is the reflectance, and the dotted curve is the absorbance. From FIG. 1, the phenomena are observed that the transmittance of the short-wavelength light (blue light) is lower than red light and green light is 15-25%. These phenomena will cause chromatic aberration and limit the application of the element.

Thus, how to promote the freedom of modulating the optical characteristics and how to improve the transmittance of the short-wavelength light and enhance the uniformity of the spectral response of the nanograting elements without increasing the difficulty of mold fabrication have been the problems the manufacturers are eager to overcome.

### SUMMARY OF THE INVENTION

The present invention provides a reflective polarizer, wherein two metallic materials are stacked to increase the freedom of modulating the optical characteristics of the nanograting elements, and wherein the transmittance of the short-wavelength light and the uniformity of the spectral response of the nanograting element are improved without increasing the difficulty of fabricating the molds of the nanograting element.

One embodiment of the present invention proposes a reflective polarizer, which comprises a light-permeable substrate and a grating structure. The light-permeable substrate has a first surface and a second surface opposite to the first surface. The grating structure is installed on at least one of the first surface and the second surface. The grating structure includes a first grating layer and a second grating layer. The first grating layer has a first array containing a plurality of first metallic units. The second grating layer is stacked on the first grating layer and has a second array containing a plurality of second metallic units. The first metallic units and the second metallic units are respectively made of different metallic materials.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a curve diagram schematically illustrating optical characteristic curves of a conventional reflective polarizer;

FIG. 2 is a diagram schematically illustrating a reflective polarizer according to one embodiment of the present invention;

FIG. 3 is a curve diagram schematically illustrating optical characteristic curves of a reflective polarizer according to one embodiment of the present invention;

FIG. 4 is a curve diagram schematically illustrating optical characteristic curves of a reflective polarizer according to another embodiment of the present invention;

FIG. 5 is a curve diagram schematically illustrating optical characteristic curves of a reflective polarizer according to yet another embodiment of the present invention; and

FIG. 6 is a diagram schematically illustrating a reflective polarizer according to a further embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

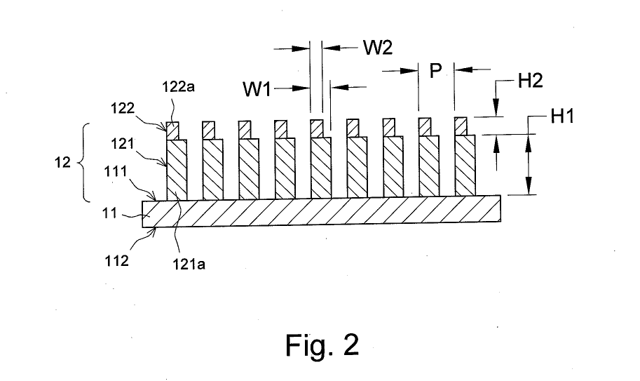

Refer to FIG. 2 a diagram schematically showing a reflective polarizer according to one embodiment of the present invention. In this embodiment, the reflective polarizer comprises a light-permeable substrate 11 and a grating structure 12. The light-permeable substrate 11 has a first surface 111 and a second surface 112 opposite to the first surface 111. The grating structure 12 is but is not limited to be installed on the first surface 111 of the light-permeable substrate 11. The grating structure 12 may alternatively be installed on the second surface 112 of the light-permeable substrate 11 or on both the first surface 111 and the second surface 112 of the light-permeable substrate 11.

The grating structure 12 includes a first grating layer 121 and a second grating layer 122. The first grating layer 121 includes a first array containing a plurality of first metallic units 121a. For example, the first metallic unit 121a may be in form of rectangles, trapezoids, or camber strips extending unidirectionally. The second grating layer 122 includes a second array containing a plurality of second metallic units 122a. Similarly, the second metallic unit 122a may be in form of rectangles, trapezoids, or camber strips extending unidirectionally, which are identical to or different from the rectangles, trapezoids, or camber strips of the first metallic units 121a. The second grating layer 122 is stacked on the first grating layer 121. The first metallic units 121a and the second metallic units 122a are respectively made of different metallic materials.

According to practical application, the first array of the first grating layer 121 is a periodic array or an aperiodic array. Similarly, the second array of the second grating layer 122 is also a periodic array or an aperiodic array. In one embodiment, the first array of the first grating layer 121 and the second array of the second grating layer 122 are periodic arrays, and the periods thereof are smaller than the half of the wavelength of the incident light. While the grating structure 12 is installed on both the first surface 111 and the second surface 112 of the light-permeable substrate 11, the period of the grating structure on the first surface 111 may be equal to or different from the period of the grating structure on the second surface 112.

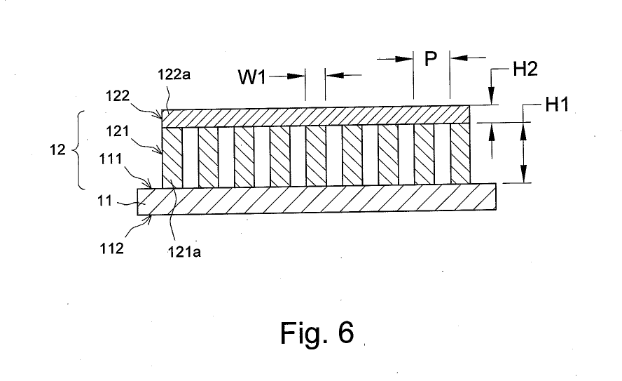

In the embodiment shown in FIG. 2, the second metallic units 122a of the second grating layer 122 are parallel stacked on the first metallic units 121a of the first grating layer 121. However, the present invention is not limited by this embodiment. For another example, the second metallic units 122a of the second grating layer 122 are extended vertically to the first metallic units 121a of the first grating layer 121, as shown in FIG. 6. In other words, the included angle between that of extending directions of the second metallic units 122a and the first metallic units 121a may range from 0 to 90 degrees, and the first metallic units 121a and the second metallic units 122a may be arranged in various ways. For example, the second metallic units 122a are directly stacked on the first metallic units 121a. For another example, a dielectric material is filled to the gap between each two first metallic units 121a, and then the second metallic units 122a is stacked on the first metallic units 121a. For a further example, the second metallic units 122a and the first metallic units 121a may be respectively formed on two different substrates 11 beforehand, and then one substrate 11 is stacked on the other substrate 11.

In one embodiment, the second metallic units 122a extend parallel to the first metallic units 121a, and the sum of the width W1 of the first metallic units 121a and the width W2 of the second metallic units 122a is smaller or equal to the period P of the first metallic units 121a. In one embodiment, the second metallic units 122a extend vertically to the first metallic units 121a; the first metallic units 121a has a higher extinction coefficient; for example, the first metallic units 121a is made of a metallic material having a higher imaginary part of the refractive rate; the second metallic units 122a is made of a material having a higher electric conductivity. For example, the first metallic units 121a may be made of aluminum or an aluminum alloy, and the second metallic units 122a may be made of a high electric conductivity material, such as gold, silver, copper, or an alloy containing one of gold, silver and copper.

In one embodiment, the height H1 and width W1 of the first metallic units 121a are equal to or different from the height H2 and width W2 of the second metallic units 122a. Preferably, the height H2 of the second metallic units 122a is smaller than the height H1 of the first metallic units 121a.

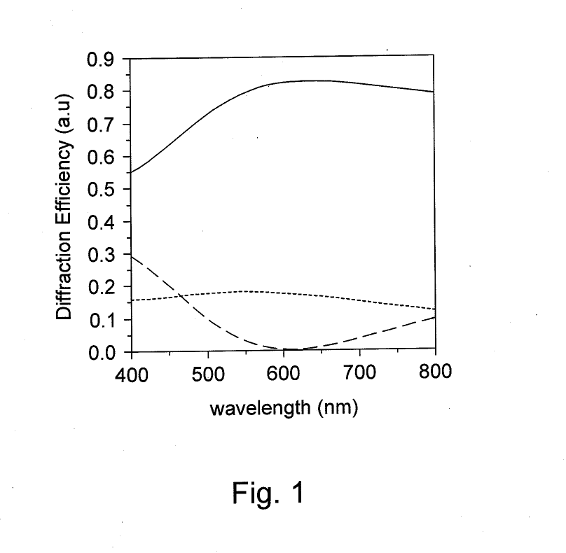

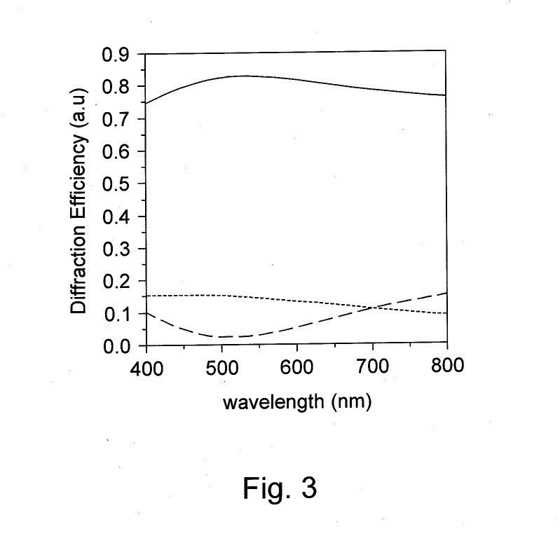

Refer to FIG. 3 for the curves of the optical characteristics of a nanograting element, which has a structure period of 100 nm and an aspect ratio of 4, and which contains first metallic units 121a made of aluminum and having a height of 170 nm and a width of 55 nm, and which contains second metallic units 122a made of silver and having a height of 50 nm and a width of 33 nm, wherein the solid curve is the transmittance, the dashed curve is the reflectance, and the dotted curve is the absorbance. In comparison with FIG. 1, the transmittance curve in FIG. 3 shows that the transmittance of the short-wavelength light (blue light) is obviously improved by 15-20%, and the reflectance is obviously reduced without influencing the transmittance distribution of the long-wavelength light (red light and green light). Therefore, the reflective polarizer of the present invention can effectively reduce chromatic aberration.

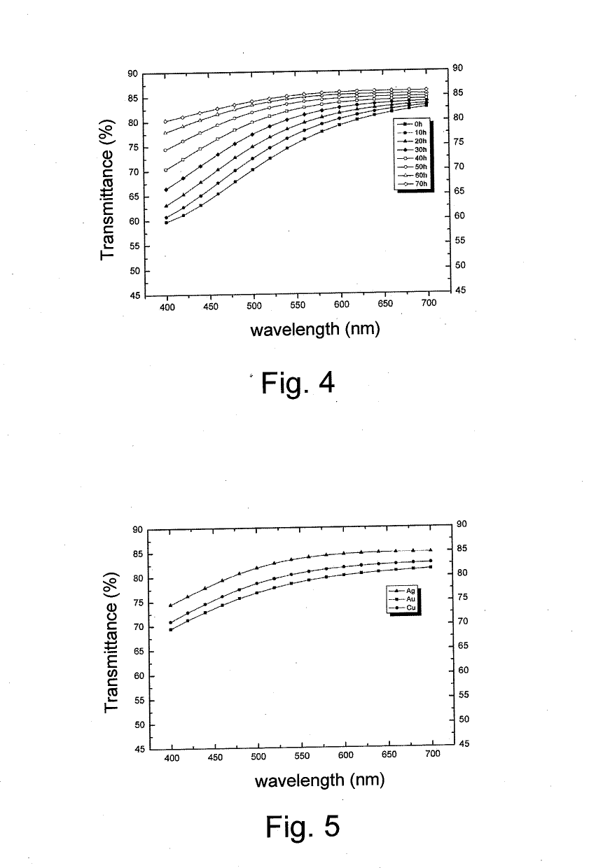

Refer to FIG. 4 for the curves of the optical characteristics of a plurality of nanograting elements, which have a structure period of 100 nm and an aspect ratio of 4, and which contain first metallic units 121a made of aluminum and having a height of 170 nm and a width of 55 nm, and which contain second metallic units 122a made of silver and having a height of 0-70 nm and a width of 33 nm. FIG. 4 shows that the transmittance of blue light increases with the heights of the second metallic units 122a (respectively designated by 0 h-70 h).

Refer to FIG. 5 for the curves of the optical characteristics of a plurality of nanograting elements, which have a structure period of 100 nm and an aspect ratio of 4, and which contain first metallic units 121a made of aluminum and having a height of 170 nm and a width of 55 nm, and which contain second metallic units 122a made of gold, silver and copper respectively and having a height of 50 nm and a width of 33 nm. FIG. 5 shows that different metallic materials (respectively designated by Au, Ag and Cu) have different effects on the transmittance of the short-wavelength light (blue light).

In conclusion, the present invention proposes a reflective polarizer, whose nanograting element is formed via stacking two metallic materials, and whose optical characteristics can be regulated via varying the period, line width and height of the nanograting element. Further, the optical characteristics of the reflective polarizer can also be regulated via selecting the combination of the materials of the metallic units and varying the period, line width and height of the upper metallic units. Therefore, the present invention can promote the freedom of modulating the optical characteristics of the reflective polarizer. Furthermore, the present invention improves the transmittance of the short-wavelength light and the uniformity of the spectral response of the nanograting element without increasing the difficulty of fabricating the mold of the nanograting structure.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A reflective polarizer comprising:
a light-permeable substrate having a first surface and a second surface opposite to said first surface; and
a grating structure arranged on at least one of said first surface and said second surface and including:
a first grating layer having a first array containing a plurality of first metallic units; and
a second grating layer stacked on said first grating layer and including a second array containing a plurality of second metallic units, wherein said first metallic units and said second metallic units are respectively made of different metallic materials.

2. The reflective polarizer according to claim 1, wherein an included angle between that of extending directions of said first metallic units and said second metallic units ranges from 0-90 degrees.

3. The reflective polarizer according to claim 1, wherein said second metallic units extend parallel to said first metallic units, and wherein a sum of a width of said first metallic unit and a width of said second metallic unit is smaller than or equal to a period of said first metallic units.

4. The reflective polarizer according to claim 1, wherein said second metallic units are stacked on said first metallic units and parallel to said first metallic units.

5. The reflective polarizer according to claim 1, wherein said second metallic units extend vertically to said first metallic units, and wherein said first metallic units have a higher extinction coefficient, and said second metallic units have a higher electric conductivity.

6. The reflective polarizer according to claim 1, wherein a height and a width of said second metallic unit are equal to or different from a height and a width of said first metallic unit.

7. The reflective polarizer according to claim 1, wherein a height of said second metallic unit is smaller than or equal to a height of said first metallic unit.

8. The reflective polarizer according to claim 1, wherein said first array or said second array is a periodic array or an aperiodic array.

9. The reflective polarizer according to claim 1, wherein both said first array and said second array are periodic arrays, and wherein a period of each of said first array and said second array is smaller than a half of a wavelength of an incident light.

10. The reflective polarizer according to claim 1, wherein said grating structure is installed on said first surface and said second surface, and wherein a period of said grating structure on said first surface is equal to or different from a period of said grating structure on said second surface.

11. The reflective polarizer according to claim 1, wherein said first metallic units or said second metallic units are in form of rectangles, trapezoids, or camber strips extending unidirectionally.

12. The reflective polarizer according to claim 1, wherein said first metallic units comprises aluminum or an aluminum alloy.

13. The reflective polarizer according to claim 1, wherein said second metallic units comprises gold, silver, copper, or an alloy containing one of gold, silver and copper.
